(19) United States
(12) Patent Application Publication
(10) Pub. No.: US 2013/0126399 A1
(43) Pub. Date: May 23, 2013

(54) METHOD FOR CLASSIFYING OBJECTS CONTAINED IN SEED LOTS AND CORRESPONDING USE FOR PRODUCING SEED

(71) Applicant: Antje Wolff, Timmendorfer Strand (DE)

(72) Inventor: Antje Wolff, Timmendorfer Strand (DE)

(73) Assignee: Strube GmbH & Co. KG, Sollingen (DE)

(21) Appl. No.: 13/807,114

(22) PCT Filed: Jun. 30, 2011
(86) PCT No.: PCT/EP2011/061071

§ 371 Date: Jan. 30, 2013

(30) Foreign Application Priority Data
Jul. 2, 2010 (DE) 10 2010 030 908.7

(51) Int. Cl. B07C 5/342

(52) U.S. Cl. CPC B07C 5/342
USPC 209/555

(57) ABSTRACT

The present invention concerns a method for classifying (704) objects (3) contained in seed lots, in which characteristics of the objects (3) are determined using at least one non-invasive process (702, 703), wherein a light-sectioning procedure (702), by means of which the objects (3) are three-dimensionally recorded and at least one spatial characteristic of the objects (3) is determined, is used as at least one non-invasive process (602, 603), and wherein characteristics which have been determined by the laser light-sectioning procedure (702) or by the laser light-sectioning procedure (702) and at least one further non-invasive process (602, 603) are used jointly for describing the objects (3) to perform the classification.

The present invention relates to a method for classifying objects contained in seed lots, a method for examining, assessing and/or preparing seed, an associated apparatus and a corresponding use for the production of seed that has been graded according to shape and size.

### PRIOR ART

Although the present application relates primarily to sugar beet seed, the methods and apparatus described may also be used to advantage in other sectors, for example in the investigation and/or preparation of other seeds, such as cereal seeds.

Modern high performance sugar beet seed passes through a series of laborious purification and preparation steps during manufacture. The purpose of these steps is to produce seed with as homogeneous a size distribution as possible to facilitate mechanical sowing and achieve the highest possible quality. Ideally, seed of this kind has an emergence rate of 100%, i.e. for each seed ball or seed sown a sugar beet can be expected to be harvested.

In order to ensure highly efficient harvesting of fields of sugar beet strenuous efforts are made to produce exclusively monogerm seed, as far as possible. The genus Beta in its wild forms is known to produce polycarpous seed balls, i.e. compound fruits, in which 1 to 5 seeds form a unit with the woody ovary. Traditionally, for growing beets, there was therefore a need to separate the beets after emergence, a very labour-intensive task, or to segment the seed balls by machine beforehand. Modern cultures, by contrast, are genetically monogerm, so that ideally they produce exclusively monocarpous seeds. However, in practice, the seed obtained always contains a certain proportion of bigerm seed balls which cannot be adequately separated using conventional methods.

In the preparation of sugar beet seed, by which is meant, within the scope of this application, all the steps carried out on the seed such as for example cleaning and grading by shape and size, cleaning processes may be carried out for example using screening devices, sorters and apparatus for removing stubble and stones, processes for sorting sizes using mechanical round-hole and slotted sieves and gravity sorting methods. After preparation, as a rule only 20% of the raw goods harvested go on sale.

Because of the irregular three-dimensional structure of the sugar beet seed which makes mechanical individual placement in the field significantly more difficult, the prepared seed is usually subsequently pelleted.

The seed preparation processes mentioned above which are separate from one another have proved laborious in practice, as a number of different machines are used the settings of which have to be suitably adapted, and between which the seed has to be conveyed. The seed qualities obtained as a result are often inadequate. In particular, the separation of monogerm and bigerm seed balls proves difficult, as the separation of smaller bigerm from larger monogerm seed balls or bicarpous but monogerm seed balls is often not satisfactorily possible using mechanical sieves.

In the purity testing of cereal and sugar beet seed, which is a statutory requirement, normally a defined amount of seed (for example 100 g) is counted out manually and the proportion of so-called rubbish, i.e. foreign seeds (weeds or other seeds), clumps of earth, pieces of leaf, stalks, stubble, fragments and the like, is determined. This process is also exceptionally labour-intensive and its results depend to a high degree on the reliability of the staff employed.

DD 255 097 A1 discloses an apparatus for grading plant seeds by density, which uses a first detector known per se (for example an optical length measuring device) to determine a mechanical dimension of the seed and a second detector, also known per se (for example an X-ray device) to determine the level of absorption of a particular electromagnetic radiation by the seed, and an evaluating and counting unit. Using this apparatus, seeds that have previously been singled are measured individually in one direction and then an absorption property of these seeds is determined in the direction of measurement.

A disadvantage of the process of DD 255 097 A1, apart from the obligatory singling and individual inspection of the seeds, with the resulting low throughput, is that the seeds inspected are only inadequately measured and the process is not viable for use particularly on irregularly shaped seeds.

US 2007/0262002 A1 proposes a process for detecting cracks inside grains of rice. For this, the rice grains are singled and slide over a chute while being irradiated with LED or laser light at a certain point. Light that has passed through the grains is detected using a CCD camera. In order to avoid falsely detecting surface scratches as internal cracks within the grain of rice, this publication proposes the use of light of different colours that shines through the rice grains, the associated light sources being arranged at specific angles to the illuminated rice grain. From the difference between the CCD camera images obtained with the different colours it is possible to draw conclusions as to the presence of cracks inside a rice grain, as surface scratches are subtracted from this. The process proposed here is not suitable for the three-dimensional measurement of the objects being examined.

There is therefore a continued need for improvements in the inspection and preparation of seed lots.

### DISCLOSURE OF THE INVENTION

Against this background the present invention proposes a method of classifying objects contained in seed lots, a method of inspecting, assessing and/or preparing seed and a corresponding use for preparing seed graded by size and shape having the features of the independent patent claims. Preferred embodiments are the subject of the sub-claims and the description that follows.

### Advantages of the Invention

The classifying method according to the invention comprises examining the objects using at least one non-invasive process and thus determining features of the objects. A light sectioning method is used according to the invention as at least one non-invasive process, by means of which the objects are three-dimensionally captured or recorded, while at least one spatial feature of the objects is determined. Also, features that have been determined by the light sectioning process per se or by the light sectioning process and at least one other non-invasive process are used jointly to describe the objects, for the classification process. A spatial extent and/or a volume and/or a spatial shape and/or a surface quality of the objects is detected as a spatial feature.

The present invention encompasses in particular optical, spectroscopic and imaging processes as the additional non-invasive process mentioned.

By optical processes are meant all processes based on the interaction of light with materials. Light here means in particular the visible part of the electromagnetic spectrum in the range between 380 nm and 780 nm, but if desired also the frequency range starting from a frequency of 1 THz up to 300 THz. This therefore also includes invisible light such as infra-red light or ultraviolet light. Consequently, optical examination methods primarily yield information as to optical properties, particularly of the surface of a sample under investigation.

Using spectroscopic processes it is possible to determine the energy spectrum of an object being examined. Spectroscopic processes may be based on an optical interaction of light with material, i.e. they constitute optical processes. However, spectroscopic processes may also encompass the use of other regions of the electromagnetic spectrum, such as X-ray radiation (in the case of X-ray (absorption) spectroscopy), UV radiation (as in fluorescence spectroscopy), microwaves (microwave spectroscopy) or radio waves (nuclear resonance spectroscopy), as well as particles such as electrons or ions. An object being examined may be excited with one type of radiation and a different irradiation of the object being examined may be examined in the form of another type of radiation. When an object being examined is radiated, transmission or absorption spectra are obtained which allow conclusions to be drawn regarding the interaction of the material with the radiation or the irradiated particles. Spectroscopic examination of a sample, particularly when the sample is penetrated by the radiation or particles used, makes it possible to pronounce on the spectrum under consideration with information from inside the sample as well.

Imaging processes generate an image from measured values of a real object, the measured value or information derived therefrom being locally resolved and visualised in coded form by means of brightness values or colours. The measured values may in turn originate from a (locally resolved) optical and/or spectroscopic examination. Typical imaging processes are photographic processes in visible or non-visible light, two- and three-dimensional X-ray processes and NMR imaging.

When examining seed lots according to the invention a high throughput is desirable. This means that individual seeds cannot be examined or measured one after another. Otherwise, for example with a three-dimensional X-ray process, each individual seed could be detected and displayed in three dimensions by subsequent image processing. A process of this kind cannot be carried out with the desired speed of throughput using the technical possibilities currently available. The invention makes use of a light sectioning process (which will be explained hereinafter) for the three-dimensional capturing (recording) of the objects in a seed lot. The advantage here is that a large number of individual objects (seeds) can be examined simultaneously. The light sectioning process provides information about the three-dimensional shape of the object being examined. The classification of an object can then be carried out on the basis of two or more features which have been obtained only by the light sectioning process, as explained hereinafter, or, in a particularly advantageous embodiment, by means of two or more features that originate on the one hand from the light sectioning process and on the other hand from a further non-invasive process. In particular, a further non-invasive process of this kind may provide information regarding the inner and/or outer nature of the object, hereinafter referred to as “anatomical and/or morphological features”. The prerequisite for detecting anatomical features is that the radiation used in this process at least partly penetrates through the object. In other cases in which the interaction is limited to the surface or particular surface layers of the object, it is possible to make statements regarding morphological properties. In this way, the invention can provide information as to the three-dimensional configuration and anatomical and/or morphological features of a plurality of objects examined at the same time.

Optical processes for measuring three-dimensional structures are mostly based on the triangulation or stereo principle. Moreover, interferometric measuring methods may be used, particularly for measuring microstructures of surfaces.

In simple triangulation processes a point of light is projected onto the surface of an object that is to be measured and is observed from a direction that is different from the direction of illumination (i.e. at a triangulation angle). The coordinates of the illuminated point can then be determined from the spatial orientation of the projection beam and the triangulation angle. Single-point triangulation processes are precise and clear, but because of the point-by-point scanning of the surface they are also slow.

Further developed processes based on triangulation that may be used to particular advantage within the scope of the invention are the light sectioning technique and stripe projection.

In light sectioning methods, instead of a single point, a line is projected onto the surface of the object that is to be measured. As in the single point triangulation methods, this line is observed from at least one direction that is different from the direction of illumination with an electronic camera, each change in the surface configuration leading to a defined deflection in the camera image. The spatial coordinates of the illuminated points (height profile) are determined in the same manner as mentioned above. As a result of the linear scanning, there are clear advantages of speed.

In the closely related laser light sectioning triangulation method, which is also categorized as a light sectioning process, the object to be measured is illuminated by means of a laser beam that is imaged, by means of a linear optical device, onto the surface of the object to be measured. Compared with the normal light sectioning technique, there are advantages of precision as a result of the slight lateral extent of the line of laser light. In particular, using the laser light sectioning technique it is possible to detect fine surface structures or roughnesses and, as explained hereinafter, this can be used to distinguish the desired seed having a specific roughness from foreign seed or rubbish with a different roughness. This may particularly advantageously be used to distinguish between sugar beet seed and cereal seed in the same batch.

Stripe projection, which should also be counted as a light sectioning process, is a further development of the light sectioning technique in which a number of lines are projected simultaneously onto the surface of the measured object. The intensity of these lines varies periodically in the lateral direction and makes the individual lines distinguishable for the observation camera.

Another group of optical processes that may advantageously be used in conjunction with the light sectioning technique are, for example, binocular stereo processes. Binocular stereo processes are based on the fact that two views of an object taken from different viewing angles make it possible to draw conclusions as to their three-dimensional configuration. Using software algorithms, object features are identified in the two photographs by correspondence analysis. The different positions of this feature in the two images provide a measurement of the depth of the feature in three-dimensional space. The binocular stereo principle can be expanded from two views to a plurality of views, thus making it possible to obtain more precise information and making the correspondence analysis more reliable.

Photometric stereo processes may also advantageously be used in conjunction with light sectioning processes. They use different illumination conditions in order to determine the shape of objects. Unlike in binocular stereo processes the viewing angle remains fixed. On the basis of the brightness in the individual directions of illumination conclusions can be drawn as to the slope of the surface of the object. Not only the spatial depth but the mathematical derivation is thus measured. Photometric stereo processes are particularly well suited to determining local object structures (i.e. for example surface features); global structural measurements, however, are frequently beset with errors.

As already mentioned, a process according to the invention for classifying objects contained in seed lots comprises the use of a light sectioning process. The advantage is that the measurement can be carried out in contactless manner and hence without any mechanical effects on the object, i.e. non-invasively. Moreover, a large number of points on an object can be recorded simultaneously, leading to a reduction in the measuring time and making it possible to record a plurality of objects contained in a stream of seed simultaneously for classification purposes.

In contrast to the above-mentioned methods of examination used in the prior art the objects under examination do not therefore need to be examined individually, but can be examined side by side at a high throughput, e.g. on a conveyor belt.

According to the invention a plurality of features of the objects are determined by one or more corresponding processes and are used jointly for description and subsequent classification. A sequentially cascading arrangement of the objects (i.e. for example according to size, first of all, and then by surface nature, then by morphological features, etc.) may be carried out or individuals from a basic population may be grouped into specific categories on the basis of particular combinations of features detected. Advantageously individuals are described by means of a number of features at the same time. The classification features and combinations of features can be taught to a learning system and optimised on the basis of the results obtained (such as for example a degree of purity and efficacy).

As already explained, using the light sectioning process, geometric properties, i.e. spatial extent and/or volume of the objects, are detected quickly and reliably. The geometric properties determined can then be correlated with one another and used to classify the objects under examination. For example, when examining round seed, as explained in more detail hereinafter, an object with a large ratio of length to width can be classified as so-called rubbish, which has to be separated out of a corresponding seed lot.

A process of this kind may particularly advantageously be carried out using thresholds, where specific desired criteria can be defined for specific classification categories. For example, seed is ideally spherical in shape to enable it to be sowed by machine without any problems. Seed that exceeds a specified deviation from the spherical shape can therefore be separated out. Seed can also be divided into shape categories on the basis of shape parameters. Such sorting or preparation on the basis of shape parameters is referred to as “grading by shape” within the scope of this application. It may be combined in particular with grading by size, which is also advantageously carried out using the light sectioning method. In this way, it is possible to produce seed fractions that are precisely described by their shape and size features, which have defined mechanical application properties.

Conventionally, sugar beet seed is pelleted, as explained above, to improve its ease of sowing. Mechanical seed drills for sugar beet seed conventionally comprise applicators with cavities, each of which can hold a seed ball or seed. The pelleting is intended to ensure that only one seed ball can actually be held in a corresponding cavity and thus delivered individually. However, at the same time, the pelleting significantly increases the volume of the seed (roughly trebles it), leading to the need to refill the seed drills frequently and thus resulting in a less economical sowing operation. The skilled man is also aware that pelleted sugar beet seed has poorer emergence properties. Thus, the coating mass used keeps water away from the seed in dry conditions, making it unavailable to the seed. On the other hand, in very wet conditions, the coating mass absorbs excessive amounts of water (“becomes soaked”) and therefore often suffocates the seed.

Therefore, if seed of an “ideal” three-dimensional shape can be produced using the method according to the invention, this can be sown using suitably adapted seed drills without any pelleting. The absence of pelleting of the seed has a beneficial effect on its ease of sowing and also on its emergence properties in the field. The invention therefore also encompasses the use of a classification process as explained hereinbefore for the production of non-pelleted seed, particularly sugar beet seed, graded by shape and size within the scope of the definition provided hereinbefore.

The process according to the invention therefore enables very rapid, reliable and non-invasive measurement of seed components, for example of seeds or fruits contained in the seed lot, of bits of leaf, soil, weed seeds and the like. Within the scope of the process according to the invention, seeds or fruits may for example be placed in a single layer on a conveyor belt by means of suitable singling devices and passed along under a bar-type laser and one or more vertical imaging cameras to inspect their shape and size. Vertical profiles of the individual seeds are produced by means of the deviations in the points of light from the zero line of the belt and different geometric parameters (parameters of shape, surface and size) are measured by evaluating the profiles. With the aid of these measured parameters, seeds or fruits can be distinguished from leaf residues, stubble, clumps of earth and stones and other foreign bodies and the seed can be recognised according to its actual measurements in all three dimensions.

A spatial shape and/or a surface nature of the objects can also be detected as at least one spatial feature. The spatial features explained hereinbefore are thus not limited to measurements of length and width and a corresponding volume but also include, for example, edge and/or surface properties such as roughness and geometric shape. Thus, bigerm sugar beet seed for example has a substantially rectangular shape in plan view and a marked angularity, whereas wheat seeds (with otherwise similar size features) are oval in longitudinal section and have little angularity. For example, sugar beet seed (with marked roughness) can also be distinguished from weed seeds (with a smoother surface) by examination of the surface structure.

As explained, the light sectioning process mentioned is particularly advantageously followed by at least one further non-invasive process. This may advantageously be an imaging process, particularly ultrasound, X-ray or magnetic resonance imaging. The above-mentioned optical or imaging processes also advantageously comprise a determination of the colour. This makes it possible for example to detect fungal attack reliably or to differentiate objects with otherwise identical parameters of size and shape.

An imaging process of this kind can be used for example to obtain two-dimensional X-ray sectional images which allow a differentiation between seeds and other objects such as stones or clumps of earth. If objects are recognised as being seeds, the associated (X-ray section) images can be subjected to an image processing method. In the course of this image processing method the image data may be segmented, for example, in other words image areas or areas of examination data may be assigned to areas of an object under investigation. In this way, morphological and/or anatomical features of the objects, for example of seeds or seed balls, can be determined and used to describe the quality of a seed. Thus the fullness of the fruit with seeds and endosperm is crucial to its emergence characteristics in the field. Therefore, if empty cavities of a certain size are detected within a fruit this fruit may have to be rejected.

It is also particularly advantageous to use a spectroscopic process by means of which at least one spectroscopic feature of the objects is detected. Spectroscopic processes of this kind, such as for example nuclear resonance, electron spin resonance, microwave, vibration, infra-red, RAMAN, UV-VIS, fluorescence, atomic, X-ray and/or gamma ray spectroscopy are theoretically known for the examination of material properties (composition of substances, measurement of concentrations). Such processes may be used to particular advantage to determine an absorption feature, or a distribution of absorption features in an object. In contrast to the imaging processes explained previously, spectroscopic processes are very quick and are therefore suitable for a high seed throughput. There is no need for complicated image processing methods. The absorption features measured may for example be used together with the geometric properties to describe the objects.

For example, in the case of objects of identical size, identical three-dimensional extent and similar visual surface nature it is possible to distinguish clearly between clumps of earth or stones and seeds by determining the density or a spectroscopic resonance or permeability, which is not possible with conventional processes, particularly in the case of sugar beet seed. Moreover, this also makes it possible to distinguish completely full seeds or fruits (i.e. seeds or fruits with a sufficiently well formed endosperm) from seeds with empty cavities. The process envisaged thus provides a replacement or support for gravity-based processes used hitherto.

In particular, a combination of spectroscopic features with features of shape provides clear information as to the nature of the objects being examined, where an individual examination process provides ambiguous results. As already explained, this refers for example to clumps of earth and seeds which may possibly have identical geometric shapes but differ in their transmission characteristics.

As mentioned several times, the processes referred to can be used to determine the degree of fullness of a fruit with germ or embryo tissue and this degree of fullness can then be correlated with a volume and/or an expansion of the fruit. Using this and the other methods described hereinbefore, and with a knowledge of a three-dimensional shape (volume, extent, geometry), it is possible to obtain a particularly high homogeneity in the seed obtained, i.e. within a calibration stage, on the basis of information as to the particular degree of fullness of the fruit. As a result, a particularly uniform and homogeneous emergence in the field can be expected.

Another advantageous embodiment comprises at least one further non-invasive examination in the form of an optical method by means of which at least one optical feature of the objects is determined. For certain problems, as explained in more detail hereinafter, an additional optical assessment may be used to classify seed. Thus, by optical inspection, wheat seed can be distinguished from clumps of earth, something that cannot always be done with sugar beet seed. Particularly advantageously, optical features may comprise a colour and/or a fluorescent quality.

It should be understood that with all the processes mentioned hereinbefore the objects can be at least partly recorded and/or measured three-dimensionally. In this context, for example, an imaging process can be carried out in two section planes, in order to obtain more reliable information on anatomical and/or morphological properties of the objects; using spectroscopic processes an absorption profile can be determined through at least two planes or section lines of the objects. The spatial properties of the objects are also determined at least partly three-dimensionally. It will be understood that objects examined by a light sectioning method on a substrate cannot be geometrically recorded in their entirety as the part of the object resting on the transporting device is not reached by the laser beam and/or by the camera. However, in this context, it has proved expedient to determine only “vertical data” of the objects disposed on the substrate.

The process according to the invention can be used to particular advantage to classify the objects in the seed lots as particles of earth, stones, stalks, leaf residues, blossom residues, weed seeds and/or seeds or fruits of at least one shape and/or size category and/or with at least one morphological property. Foreign bodies or unwanted seeds or fruits may be separated out from the seed and discarded.

The process is particularly suitable for classifying the seeds or fruits themselves. Thus it is possible to distinguish between bicarpous-monogerm, bicarpous-bigerm and monocarpous-monogerm fruits. Bicarpous-monogerm seeds which have two chambers, only one of which contains a seed, are conventionally impossible or very difficult to distinguish from bicarpous-bigerm seeds. As sugar beet seed should ideally produce only one beet to each seed ball planted, as mentioned previously, bigerm seed balls have to be separated out. The bicarpous-monogerm seed balls, if reliably detected, can however be left in the seed, thereby increasing the degree of utilisation of the raw seed material.

To summarise, it can be said that, by precise measurement and sorting into narrow categories, the present invention allows the preparation of “high-tech” seed for which no pelleting is required. The absence of pelleting has the advantage of enormously reducing the volume and weight of the seed to be planted, better germination qualities both in wet ground and in drought conditions and, not least, a reduction in costs. The invention provides best results with a combination of two sensor systems, i.e. by correlating (at least) two types of feature, which include spatial, morphological, spectroscopic and optical features, and comprise the examination of surface features on the one hand and of internal morphology, on the other hand. Finally, the invention may lead to savings on conventional grading equipment with its corresponding grading processes (vibration, gravitation, sieve holes, etc.) with the disadvantages referred to. It should also be pointed out that according to the invention several fractions of seeds can also be produced, each fraction having seeds with the same features (geometric, anatomical, morphological and/or optical).

The process according to the invention may be used in particular in seed purity analyses (assessment). “Poor fractions” can be excluded and like the “good fractions” obtained can be subjected to visual reassessment and a corresponding statistical evaluation.

Table 1 shows an example of a composition of a contaminated sugar beet/raw seed lot given in % and parts by mass. The objective of the seed purification is to obtain the highest possible content of sugar beet seed balls free from rubbish (i.e. unwanted matter).

As can be seen from Table 2, the purification according to the invention yields a degree of purity of 99.43 with minimal amounts of rubbish in the good fraction. The percentage of seed balls in the poor fraction (Table 3) is 72.2%, but this amounts to only 7% by weight of that contained in the good fraction. In daily use the process makes it possible to grade around 7,000,000 particles (corresponding to about 70 kg of seed) per hour.

TABLE 1
Example of a composition of a contaminated sugar beet/raw seed lot

| Type | Frequency % | g |
|---|---|---|
| crude seed balls | 88.75 | 2662 |
| stubble | 8.00 | 240 |
| seed balls with stubble | 0.15 | 4.5 |
| leaves | 1.50 | 45 |
| blossom residues | 1/25 | 37.5 |
| weeds | 0.23 | 6.9 |
| clumps | 1.09 | 32.7 |

TABLE 2
Composition of the “good fraction” after purification of the seed lot
according to the invention

| Type | Frequency % | g |
|---|---|---|
| crude seed balls | 99.43 | 2485 |
| stubble | 0.03 | 0.75 |
| seed balls with stubble | 0.05 | 1.25 |
| leaves | 0.10 | 2.50 |
| blossom residues | 0.08 | 2.00 |
| weeds | 0.05 | 1.25 |
| clumps | 0.24 | 6.00 |

TABLE 3
Composition of the “poor fraction” after purification of the seed lot
according to the invention

| Type | Frequency % | g |
|---|---|---|
| crude seed balls | 72.2 | 177 |
| stubble | 22.14 | 239 |
| seed balls with stubble | 0.38 | 3.3 |
| leaves | 1.53 | 42.5 |
| blossom residues | 2.40 | 35.5 |
| weeds | 0.63 | 5.5 |
| clumps | 0.73 | 26.7 |

For features and advantages of the processes for examining and/or preparing seeds lots which are also proposed according to the invention reference is expressly made to the explanations provided hereinbefore.

Further advantages and embodiments of the invention will become apparent from the description and the accompanying drawings.

It will be understood that the features mentioned hereinbefore and those that are to be explained hereinafter may be used not only in the particular combination specified but also in other combinations or on their own, without departing from the scope of the present invention.

The invention is schematically represented in the drawings by an embodiment by way of example and is described in detail hereinafter by reference to the drawings.

### DESCRIPTION OF THE FIGURES

FIG. 1 shows a schematic representation of an apparatus according to a particularly preferred embodiment of the invention.

FIG. 2 shows surface image data obtained within the scope of a particularly preferred embodiment of the process according to the invention.

FIG. 3 shows X-ray irradiation data obtained within the scope of a particularly preferred embodiment of the process according to the invention.

FIG. 4 shows X-ray sectional image data and correspondingly associated morphological features obtained within the scope of a particularly preferred embodiment of the process according to the invention.

FIG. 5 shows X-ray sectional image data of a seed mixture with rubbish, obtained within the scope of a particularly preferred embodiment of the process according to the invention.

FIG. 6 shows nuclear resonance data of constituents of a seed mixture with rubbish, obtained within the scope of a particularly preferred embodiment of the process according to the invention.

FIG. 7 shows, in the form of a flow chart, a process carried out according to a particularly preferred embodiment of the invention.

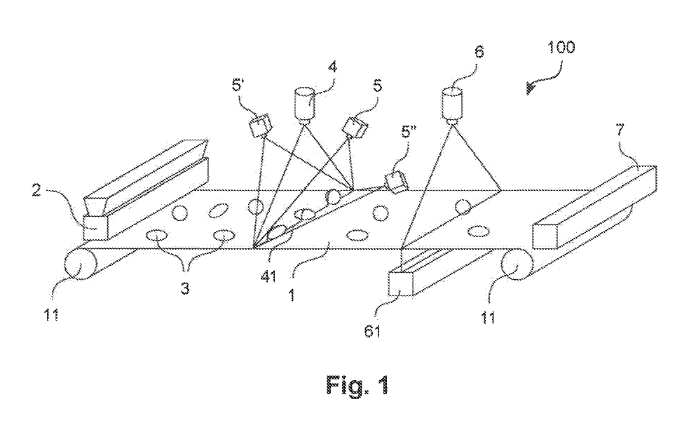

In FIG. 1 an apparatus for the classification, inspection and/or preparation of seed is shown, which is generally designated 100.

The apparatus 100 comprises a transporting device 1, for example a conveyor belt equipped with corresponding rollers 11. Objects 3 are applied in a single layer to the conveyor device 1 by means of a singling device 2, from seed lots introduced into the singling device 2. By a single layer is meant here that the objects 3 lie side by side and preferably do not overlap with one another, or overlap only by a small amount.

The apparatus 100 comprises a light source 4, for example a bar-type laser. The apparatus 100 is set up to use light sectioning technology. As explained previously, however, the process according to the invention may also be carried out using stereometric and/or interferometric techniques. A laser light sectioning process is shown by way of example and briefly explained hereinafter.

The light source 4 which, as already mentioned, is set up for example to produce a laser line 41 is directed towards the conveying device 1 and projects a laser line substantially at right angles to the direction of conveying of the conveying device. When objects 3 pass the laser line 41, a deflection of this laser line 41 can be observed when it is viewed from the side. The deflection of the line of laser light can be observed for example using suitable observation cameras 5, 5′, 5″, which are aligned with the line of laser light, enclosing suitable triangulation angles. Generally, in light sectioning processes of this kind it is essential to use at least one camera. However, accuracy is increased by the use of two or more cameras 5, 5′, 5″, arranged at different triangulation angles.

The cameras 5, 5′, 5″ are connected to an evaluating device (not shown), for example a high powered computer. In the processing device the individual or partial images obtained by the cameras 5, 5′, 5″ are combined to form data sets and geometric data of each object 3 are calculated from them. These data can also be processed to form three-dimensional representations of the objects 3 observed. At least one of the cameras 5, 5′ and 5″ may also be embodied as a visual observation camera, for example as a colour camera, so that for example a three-dimensional representation of the objects 3 can be obtained using one or more cameras 5, 5′, 5″ embodied as measuring cameras and the colour camera yields additional colour information on the three-dimensional objects 3.

In particular applications, for example when classifying cereal seed, different colour information relating to the objects 3 can be used, as mentioned previously, for classifying the objects 3 as seed (cereal grains) or rubbish (such as clumps of earth, for example).

Because of the three-dimensional data gathering of the device according to the invention the alignment of the objects 3 on the transporting device 3 is no longer of any importance, as the three-dimensional spatial measurements of the objects are captured in each case. This represents a significant advantage over conventional seed evaluation processes as known from DD 255 097 A1, for example.

Besides a single light source 4, it is naturally also possible to use a plurality of light sources with different light properties. For example, within the scope of photometric stereo processes, illumination may be provided from two different directions and surface inclinations can be determined by one or more of the cameras 5, 5′ and 5″. The determination of fluorescence properties of seed for ascertaining quality features is known for example from EP 1 076 822 A1. Light sources that excite specific fluorescence properties of the seed can therefore also be used.

If appropriate, within the scope of the process according to the invention it is also possible to use a plurality of light sources 4 which are actuated alternately in the manner of a stroboscope, so as to enable alternating observation under different lighting conditions. Besides optical cameras 5, 5′ and 5″, it is possible to use fluorescence cameras and the like or, generally speaking, imaging devices for optical reflective properties of the objects 3 under examination.

The apparatus 100 may also be configured for stereoscopic measurement, while, as explained hereinbefore, two cameras 5, 5′, 5″ from different viewing angles or two correspondingly aligned light sources 4 may be used.

After passing the line of laser light 41 generated by the illuminating device 4, for example, the objects pass another non-invasive measuring device, represented here as an X-ray source 6 and opposing X-ray detection device 61. By means of the X-ray source 6 and the opposing detection device 61, either X-ray absorption properties (i.e. “grey-scale values” of a corresponding object) may be determined or, as desired, two-dimensional image data of the object may be obtained and evaluated accordingly.

Preferably, the X-ray detection device 61 is also connected to the evaluating device mentioned hereinbefore (not shown). The evaluation according to the invention includes in particular a correlation of different properties determined, for example, as explained previously, a correlation of a maximum expansion with a volume and/or with an X-ray absorption property and/or a property of a morphological feature determined by an X-ray imaging process.

The apparatus 100 according to the invention may further comprise a sorting device 7 wherein objects 3 classified beforehand, for example by pneumatic grading, are split into fractions.

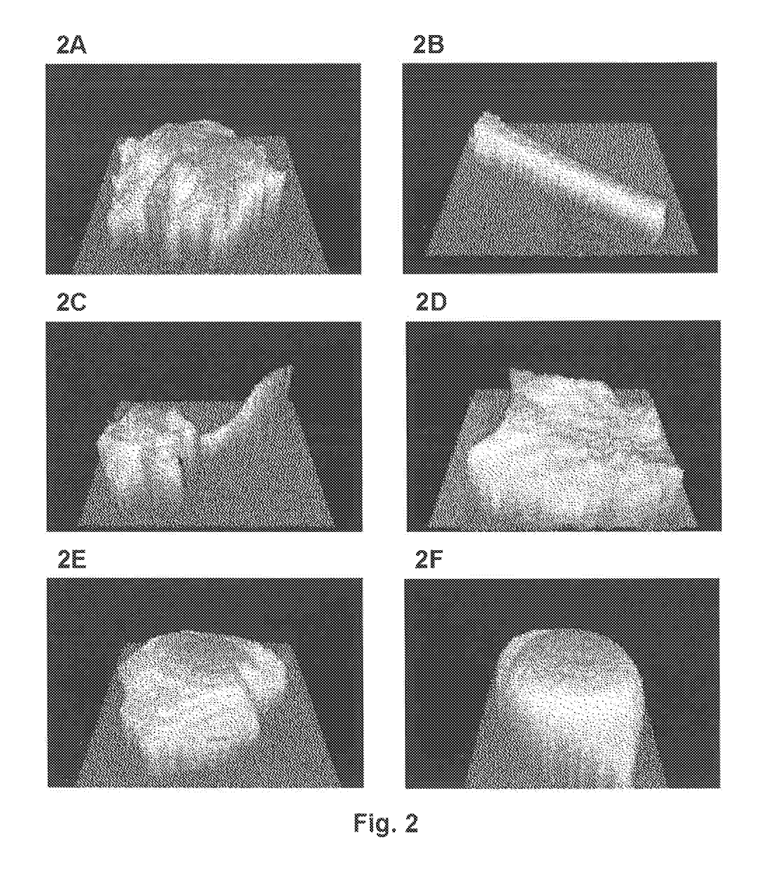

FIG. 2 shows three-dimensional examination data of objects in sugar beet seed obtained according to a particularly preferred embodiment of a process according to the invention. The Figures are reconstructed from laser light section lines drawn continuously, as may be produced by the apparatus 100.

Naturally, when objects on a surface 1 (for example in an apparatus 100) are optically examined, as explained, “vertical images” of these objects 3 are obtained. It is not readily possible to obtain a complete spatial representation because they are viewed from above. However, it has been found that within the scope of the process according to the invention a vertical image representation is sufficient and expedient for classifying objects in seed lots. As already mentioned, these vertical data may also be obtained from two observation angles and combined accordingly.

FIG. 2A shows a sugar beet seed ball which can be classified as such, for example, on the basis of its ratio of surface area to volume, in conjunction with corresponding roughness features.

FIG. 2B shows a piece of stubble to be found in sugar beet seed and classified as such by the process according to the invention. Stubble of this kind may be stalks of blossoms or fruits which are unwanted rubbish found in sugar beet seed. Stubble is characterised, within the scope of the examination process shown, by its large longitudinal dimension coupled with a small lateral dimension at the same time.

FIG. 2C shows a stubble seed ball classified according to the invention, i.e. a seed ball with stubble attached, which is also undesirable in quality seed as it is less easy to plant by machine. The classification is carried out on the basis of a combination of the features explained hereinbefore (cf. FIGS. 2A and 2B).

FIG. 2D shows a leaf fragment classified according to the invention, which is characterised by a relatively large surface area while at the same time being markedly “flat”.

FIG. 2E shows a correspondingly classified clump of earth. As is immediately apparent, clumps of earth and stones (FIG. 2E) may possibly be difficult to distinguish purely optically from the optically similar sugar beet seed balls (FIG. 2A), which means that additional processes may have to be used.

FIG. 2F shows a weed seed which has significantly less roughness by comparison with the sugar beet seed ball (FIG. 2A).

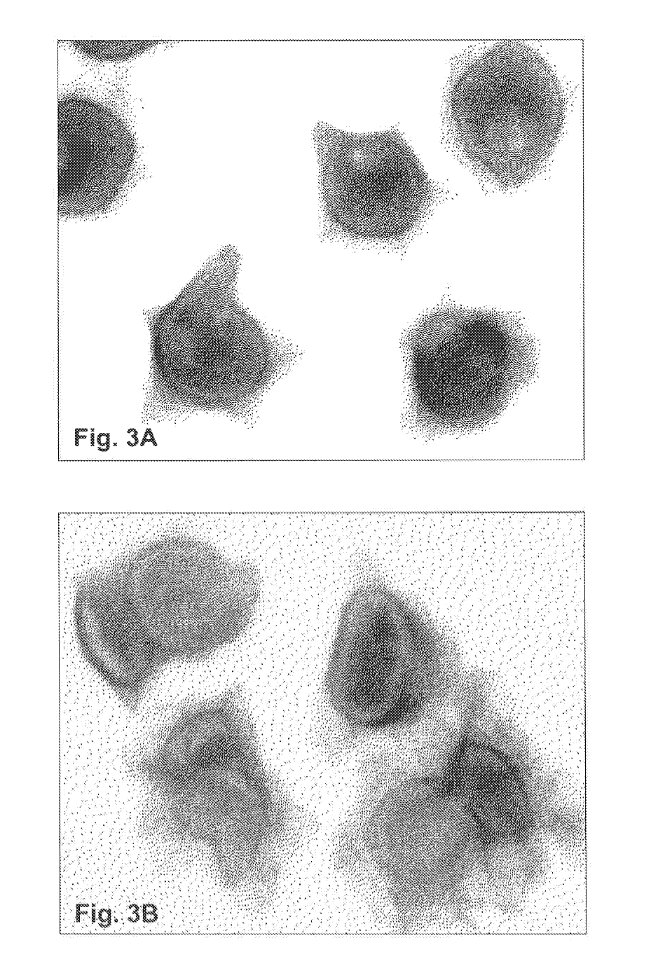

FIG. 3 shows schematic cross-sections through sugar beet seeds (irradiation images) obtained by 2D X-ray imaging. FIG. 3A shows monocarpous monogerm seed balls that are completely full. The bicarpous bigerm seed balls (i.e. seed balls with two full seeds) shown in FIG. 3B in the X-ray image can clearly be distinguished from them.

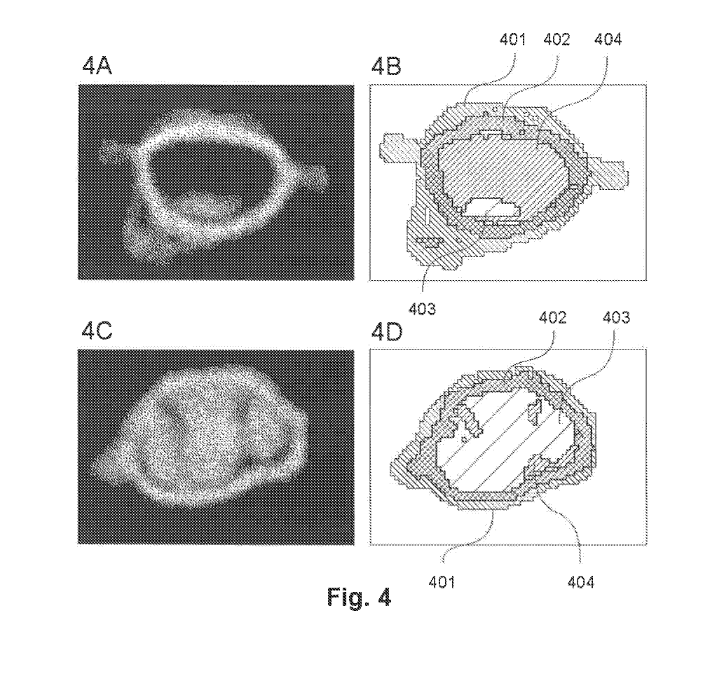

FIG. 4 shows detailed views of two sugar beet seed balls, while partial FIGS. 4A and 4C each show raw data obtained by X-ray imaging and partial FIGS. 4B and 4D show corresponding tissue information obtained by an automatic segmenting process, i.e. morphological features. In each case the soft part of the fruit coat 401, the hard part of the fruit coat 402, the seed tissue 403 (embryo and endosperm) and a cavity 404 can be differentiated. The detection of these segments 401 to 404 from the sectional images is done for example using grey scale values and by learning a corresponding recognition system.

In the seeds shown in FIG. 4, cavities 404 can thus be detected within the seed ball and allocated accordingly by the segmentation. The cavity 404 fills the seed ball almost entirely, in the case of the seed shown in partial FIGS. 4A and 4B, whereas the seed tissue 403 can scarcely be detected. The presence of the cavity 404 within a seed ball and its size in relation to the size of the seed tissue 403 and the size of these features in relation to a geometric property determined by an optical examination process may be used to particular advantage to define quality features of seed balls and carry out preparation based on them.

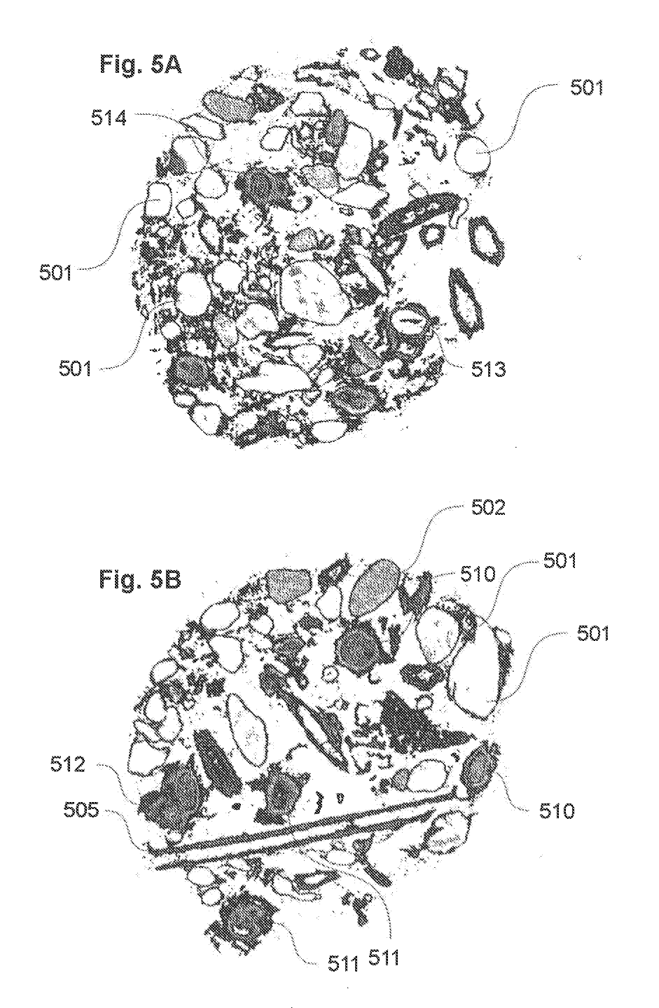

FIG. 5 shows image data of raw seed mixtures with a high proportion of rubbish, obtained by 2D X-ray imaging. The rubbish consists (among other things) of stones and clumps of earth 501 (clearly to be distinguished from seed 510 to 513 on the basis of permeability to X-rays), cereal seed 502 of a clearly different shape and different permeability to X-rays and stalk residues 505.

On seed 510 to 13, it is possible to distinguish (desired) monogerm-monocarpous seed balls 510 in which the single chamber present is completely filled, partially filled monogerm-monocarpous seed balls 511 with potentially poorer emergence properties (cf. FIGS. 4A, 4C), bicarpous and bigerm seed balls 512 and two-chamber but empty seed balls 513 that are to be removed, as well as two-chamber but monogerm seed balls 514 that can possibly be used (see above).

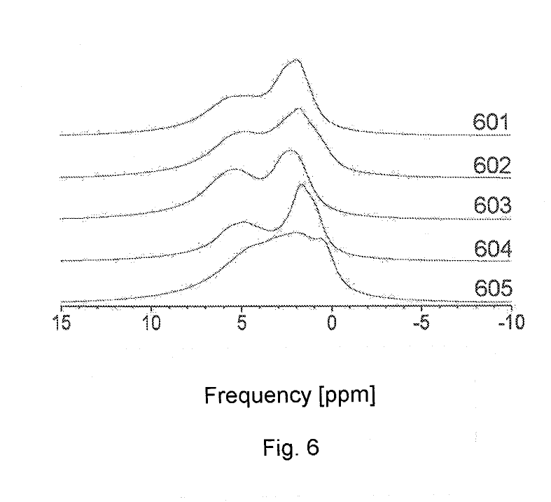

FIG. 6 shows magnetic resonance spectra 601 to 605 obtained on different components of a seed mixture, which may be used instead of or in addition to the X-ray data for classifying and sorting.

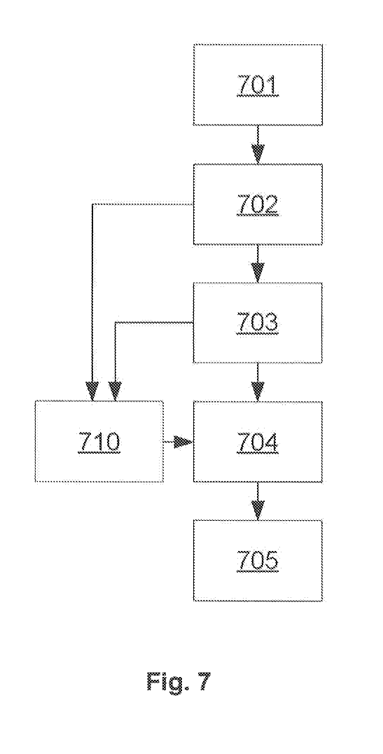

FIG. 7 schematically shows a process that takes place according to a preferred embodiment. In step 701, seed or objects contained in seed are fed into an examination apparatus such as apparatus 100 in FIG. 1. A singling device 2 may be used, for example.

In step 702 a first examination is carried out using a first non-invasive process, for example by laser sectioning technology. The examination data are supplied to an evaluating unit 710, for example.

In step 703 a second examination is carried out using a second non-invasive process, for example X-ray imaging. The examination data of this examination are also supplied to the evaluating unit 710.

In step 704 there is an evaluation of the object that is doubly investigated in steps 702 and 703 and, if desired, a suitable treatment, for example a separation process, resulting in prepared seed being obtained in step 705.

1. Method for classifying objects contained in seed lots, wherein features of the objects are determined using at least one non-invasive process characterised in that a light sectioning process is used as at least one non-invasive process by means of which the objects are captured three-dimensionally, while a spatial extent and/or volume and/or a spatial shape and/or a surface quality of the objects is determined as at least one spatial feature of the objects is determined, and in that features that have been obtained by the laser light sectioning process or by the laser light sectioning process and at least one further non-invasive process are used together for describing the objects in order to classify them.

2. Method according to claim 1, characterised in that a spectroscopic process particularly X-ray spectroscopy, is used as at least one further non-invasive process by means of which at least one spectroscopic feature of the objects is determined.

3. Method according to claim 1, characterised in that an imaging process particularly X-ray imaging, is used as at least one further non-invasive process by means of which at least one anatomical and/or morphological feature of the objects is determined.

4. Method according to claim 2, characterised in that a degree of fullness, an embryo volume and/or endosperm volume of seeds and/or fruits is determined as at least one feature.

5. (canceled)

6. (canceled)

7. Method according to claim 1, characterised in that an optical process is used, as at least one further non-invasive process by means of which at least one optical feature of the objects (3) is determined.

8. Method according to claim 7, characterised in that a colour and/or a fluorescence property is determined as at least one optical feature.

9. Method according to claim 1, characterised in that it comprises classifying the objects as soil particles, stones, stalks, leaf residues, blossom residues, weed seeds and/or seeds or fruits of at least one category of shape and/or size and/or having at least one morphological property.

10. Method according to claim 1, which is used to classify objects contained in sugar beet seed.

11. Method according to claim 1, wherein a seed lot is present as the stream of seed to be classified.

12. Method for examining, assessing and/or preparing seed, wherein objects contained in seed lots are classified using a method according to claim 1.

13. (canceled)

14. Use of a method according to claim 1, for preparing non-pelleted seed, graded according to shape and size, particularly sugar beet seed.
